(19) United States
(12) Patent Application Publication
(10) Pub. No.: US 2014/0144563 A1
(43) Pub. Date: May 29, 2014

(54) METHOD FOR PRODUCING PNEUMATIC TIRE, AND PNEUMATIC TIRE

(71) Applicant: TOYO TIRE & RUBBER CO., LTD., OSAKA-SHI (JP)

(72) Inventor: Hiroaki Narita, Osaka-shi (JP)

(21) Appl. No.: 13/942,770

(22) Filed: Jul. 16, 2013

(30) Foreign Application Priority Data
Nov. 27, 2012 (JP) 2012-258853

(51) Int. Cl. B29D 30/06; B60C 5/00

(52) U.S. Cl. CPC B29D 30/0601; B60C 5/00
USPC 152/450; 264/347

(57) ABSTRACT

In a method for producing a pneumatic tire, a vulcanizing step of heating and vulcanizing, inside a mold, an unvulcanized green tire having a pair of bead regions, side wall regions extended, respectively, from the bead regions toward the outside of the tire in the radius direction of the tire, and a tread region extended and joined to an outside end of each of the side wall regions to form a tread satisfies the following:

To/So=1.00 to 1.10 (1), and

To/Ti=0.70 to 0.90 (2).
wherein To (° C.) represents the temperature of the outside surface of the tread region in the vulcanizing step, So (° C.) represents the temperature of the outside surface of the side wall regions in the step, and Ti (° C.) represents the temperature of the inside surface of the tread region in the step.

### BACKGROUND OF THE INVENTION

1. Field of the Invention

The present invention relates to a method for producing a pneumatic tire including a vulcanizing step of heating and vulcanizing, inside a mold, an unvulcanized green tire having a pair of bead regions, side wall regions extended, respectively, from the bead regions toward the outside of the tire in the radius direction of the tire, and a tread region extended and joined to an outside end of each of the side wall regions to form a tread.

2. Description of the Related Art

In recent years, awareness of environmental protection has been heightened to generate a tendency that demands for fuel-efficient tires increase. In order to decrease tires in rolling resistance, various methods have been suggested. It is well known that silica is blended in a high proportion, in particular, into their tread rubber. This method makes it possible to decrease pneumatic tires in rolling resistance to improve the fuel consumption performance thereof.

The performance of pneumatic tires for low fuel consumption is correlated to calorie given to their tread surface when the green material of the tires is vulcanized. By restraining the calorie, the performance for low fuel consumption is improved. However, in the recent market of tires, the performance for low fuel consumption is required, and additionally this performance is required to be made consistent with the wet braking performance of the tires. However, the performance for low fuel consumption and the wet braking performance are in conflict with each other. Under the actual circumstances, the realization of the consistency is difficult.

Patent Document 1 describes a technique of producing a pneumatic tire decreased in rolling resistance by a pneumatic tire producing method including a heating step of filling a high-temperature heating medium into an inner cavity of a green tire set inside a mold, performing inner heating of heating the green tire from the inner cavity side of the tire, and outer heating of heating the mold to heat the green tire from the outside surface side of the tire, in which in the heating step, mold-temperature control is made to control the temperature of the mold into the range of 140 to 165° C.

Patent Document 2 describes a method for producing a pneumatic tire, wherein the vulcanizing temperature of the tire outside surface of a tread region of an unvulcanized tire is set into the range of 130 to 170° C., and that of the tire inside surface of the tread region of the unvulcanized tire is set into the range of 55 to 95% of the vulcanizing temperature of the tire outside surface. The technique described in this patent document prevents a problem peculiar to racing tires, which are required to heighten the side-rigidity thereof to improve steering stability, that is, prevents the breaking of a carcass cord inside a region positioned at a boundary between their tread region and each of their side wall regions, the breaking being caused by increasing the side rigidity. In this way, the tires are improved in endurance.

In a steam vulcanizing method and others, steam condensed while a green tire is vulcanized remains as a liquid drainage at the lower side of the tire. By this matter and others, at the inside surface side of the tire, the tire is made uneven in temperature between the upper side and the lower side of the tire. The unevenness causes the hindrance of the optimization of the vulcanization, and other inconveniences to promote a decline in performance of the tire. In order to overcome this drawback, Patent Document 3 describes a technique of differentiating the respective temperatures of individual zones of a tire-inside-shaping surface of an inner mold from each other when a green tire is vulcanized, and vulcanizing the tire.

In order to extract performance required for individual moieties of a pneumatic tire with good productivity, Patent Document 4 describes a technique of vulcanizing the individual moieties, such as its tread and its side walls, at different vulcanizing temperatures corresponding to respective constituent blend materials of the moieties.

[Patent Document 1] JP-A-2010-42561

[Patent Document 2] JP-A-2012-158232

[Patent Document 3] JP-A-2000-43048

[Patent Document 4] JP-A-2-223409

### SUMMARY OF THE INVENTION

However, the above-mentioned precedent techniques have the following problems: About the technique described in Patent Document 1, in order to increase and uniformize a topping rubber of a belt cord of a tire in crosslink density, the temperature of the vulcanizing mold, that is, the temperature of the outside surface of the tire is merely adjusted. Thus, no attention is paid to the tire inside surface temperature, the outside surface temperature of the side walls, nor other temperatures.

The technique described in Patent Document 2 is a technique for solving the problems peculiar to racing tires. About their side walls, the rigidity thereof is made high by making their carcass layer into a bias structure. The temperature for vulcanizing the side walls, and other matters related thereto are neither disclosed nor suggested.

In the technique described in Patent Document 3, the temperature for vulcanizing the inside surface of a tire is made substantially equal to that for vulcanizing the outside surface thereof, so that the temperature for vulcanizing its side walls is lowered to prevent the tire from being overcured. However, the tire is not improved in performance for low fuel consumption.

The technique described in Patent Document 4 is a technique about which importance is placed only on the adjustment of the outside surface temperature of a tire when a green tire thereof is vulcanized. Thus, conditions for vulcanizing the tire inside surface, and matters related thereto are neither disclosed nor suggested.

In light of the actual circumstances, the present invention has been made. An object thereof is to provide a pneumatic tire about which vulcanizing temperature conditions are optimized to make the fuel consumption performance of the tire consistent with the wet braking performance thereof; and a method for producing the tire.

The present inventor has made eager investigations about vulcanizing conditions for making the fuel consumption performance of a pneumatic tire consistent with the wet braking performance thereof. As a result, the present inventor has found out that the performance for low fuel consumption can be made consistent with the wet braking performance in a well balanced manner by (1) setting the outside surface temperature of its tread region and the outside surface temperature of its side wall regions into specified ranges, respectively, in a vulcanizing step for this tire, and (2) setting the outside surface temperature of the tread region and the inside surface temperature of the tread region into specified ranges, respectively, that is, rendering a relationship among the outside surface temperature of the tread region, the outside surface temperature of the side wall regions, and the inside surface temperature of the tread region an inseparable relationship in the vulcanizing step. On the basis of the finding, the present invention has been achieved. Accordingly, the present invention is as follows.

The method of the present invention for producing a pneumatic tire is a method including a vulcanizing step of heating and vulcanizing, inside a mold, an unvulcanized green tire having a pair of bead regions, side wall regions extended, respectively, from the bead regions toward the outside of the tire in the radius direction of the tire, and a tread region extended and joined to an outside end of each of the side wall regions to form a tread, wherein

when To (° C.) represents the temperature of the outside surface of the tread region in the vulcanizing step, So (° C.) represents the temperature of the outside surface of the side wall regions in the step, and Ti (° C.) represents the temperature of the inside surface of the tread region in the step,

the following are satisfied:

To/So=1.00 to 1.10 (1), and

To/Ti=0.70 to 0.90 (2).

In the vulcanizing step in the present invention, the outside surface temperature To (° C.) of the tread region, the outside surface temperature So (° C.) of the side wall regions, and the inside surface temperature Ti (° C.) of the tread region satisfy the relationship represented by the above-mentioned expressions (1) and (2). In other words, in the vulcanizing step, the relationship among To, So and Ti is rendered an inseparable relationship. This matter makes it possible to produce a pneumatic tire about which performance for low fuel consumption is made consistent with wet braking performance in a well balanced manner. However, if To/So is less than 1.00 in connection with the expression (1), undercure is generated in the vulcanized tire. If this ratio is more than 1.10, calorie given to the tread surface is too large so that the performance for low fuel consumption is deteriorated. If To/Ti is less than 0.70 in connection with the expression (2), undercure is generated in the vulcanized tire. If this ratio is more than 0.90, calorie for To becomes excessive so that the tire cannot exhibit performance for low fuel consumption.

In the present invention, the position of the outside surface of the tread region where the temperature To is measured may be a shoulder portion of the tread. The position of the outside surfaces of the side wall regions where the temperature So is measured may be a maximum-width portion of the side walls that contacts a mold for forming the tire. The position of the inside surface of the tread region where the temperature Ti is measured may be an inside surface portion of the tread that corresponds to the To-measured position.

In the pneumatic tire producing method, the outside surface temperature To (° C.) of the tread region is preferably 160° C. or lower. If the temperature To (° C.) is higher than 160° C., calorie of the tread outside surface becomes excessive so that the tire cannot exhibit performance for low fuel consumption.

In the pneumatic tire producing method, the inside surface temperature Ti (° C.) of the tread region is preferably higher than 185° C. If the temperature Ti (° C.) is 185° C. or lower, the tire is undercured at the inside surface side thereof. The tire cannot be turned to a finished tire.

The pneumatic tire according to the present invention is a tire produced by the producing method according to the present invention; accordingly, the tire is a tire about which fuel consumption performance and wet braking performance are made consistent with each other in a well balanced manner. Thus, the tire is a pneumatic tire excellent in both of fuel consumption performance and wet braking performance in the so-called grading system of tires.

### BRIEF DESCRIPTION OF THE DRAWINGS

FIG. 1 is a tire-meridian sectional view illustrating an example of the tire according to the present invention; and

FIG. 2 is a schematic sectional view illustrating a mold used to vulcanize a tire.

### DETAILED DESCRIPTION OF THE PREFERRED EMBODIMENTS

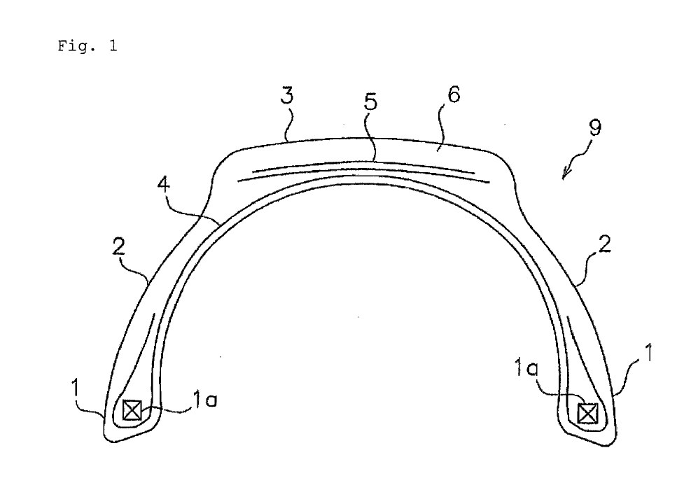

With reference to the drawings, embodiments of the present invention will be described. A tire 9 illustrated in FIG. 1 is a pneumatic tire having a pair of bead regions 1, side wall regions 2 extended, respectively, from the bead regions 1 toward the outside of the tire in the radius direction of the tire, and a tread region 3 extended and joined to an outside end of each of the side wall regions 2 to form a tread. In each of the bead regions 1, a circular bead core 1a is arranged.

A carcass layer 4 is extended from the tread region 3 through each of the side wall regions 2 to the corresponding bead region 1. Each end of the carcass layer 4 is turned back around the corresponding bead core 1a. The carcass layer 4 is made of at least one carcass ply. The carcass ply is composed of a carcass cord extended at an angle of about 90° to the circumferential direction of the tire, and covered with a topping rubber.

A belt layer 5 is bonded to the outside of the carcass layer 4 in the tread region 3, and covered with a tread rubber 6 from the outside thereof. The belt layer 5 is composed of a plurality of belt plies (two plies in the present embodiment). The belt plies are each made of a belt cord extended obliquely to the tire circumferential direction and covered with a topping rubber. The belt plies are laminated onto each other in such a manner that the belt cords cross each other to face reversely between the plies.

The tread rubber 6 may be made of only a single layer, or may be formed to have the so-called cap base structure having a base tread at the inside thereof in the tire radius direction, and a cap tread positioned outside the outer circumference of the base tread.

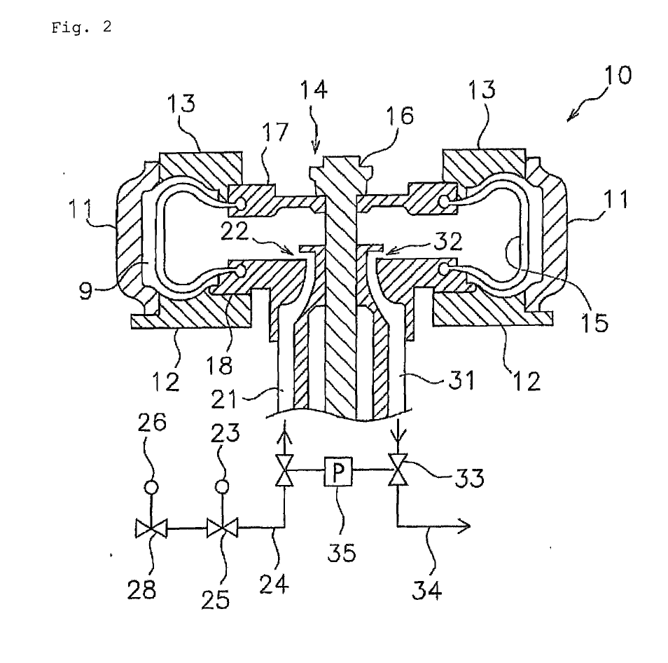

The tire 9 illustrated in FIG. 1 is a green tire, which is in an unvulcanized state. In a vulcanizing step that will be described later, the tire 9 is shaped into a tire as a product (see FIG. 2), and further a tread pattern that may be of various types is formed in the tread surface.

In the vulcanization and shaping of the tire 9, a mold 10 illustrated in FIG. 2 is used. The unvulcanized tire 9 is set, as it is, in the mold 10. Heat and pressure are applied to the tire 9 inside the mold 10 to vulcanize the tire 9.

The mold 10 has a tread mold part 11 contacting the tread of the tire 9, a lower mold part 12 contacting a tire outside surface region facing downward, and an upper mold part 13 contacting a tire outside surface region facing upward. These members are formed to be freely shifted between a mold-fastened state and a mold-opened state by means of an opening and closing mechanism (not illustrated) located around the members. The structure of the opening and closing mechanism is well known. The mold 10 is equipped with a platen plate (not illustrated) having a heating source such as an electric heater or a steam jacket. The individual mold parts are heated by effect of this plate.

At the center of the mold 10, a central mechanism 14 is arranged concentrically with the axis of the tire. Around this mechanism are located the tread mold part 11, the lower mold part 12, and the upper mold part 13. The central mechanism 14 has a bladder 15 in a rubber bag form, and a center post 16 extended in the tire axial direction. The center post 16 is equipped with an upper clamp 17 and a lower clamp 18 for grasping edge portions of the bladder 15.

From the central mechanism 14, a medium supply path 21 is vertically extended for supplying a heating medium into the bladder 15. A spout 22 is made at the upper end of the medium supply path 21. To the medium supply path 21 is connected a supply pipe 24 in which the heating medium supplied from a heating medium supply source 23 flows, and a pressurizing medium supplied from a pressurizing medium supply source 26 flows. The heating medium is supplied in accordance with opening and closing operations of a valve 25. The pressurizing medium is supplied in accordance with opening and closing operations of a valve 28.

From the central mechanism 14, a medium discharge path 31 is vertically extended for discharging a high-temperature and high-pressure fluid in which the heating medium in the bladder 15 is mixed with the pressurizing medium therein. A collecting opening 32 is made at the upper end of the medium discharging path 31. To the medium discharge path 31 is connected a discharge pipe 34 in which the high-temperature and high-pressure fluid flows. A blow valve 33 for operating the opening and closing of this pipe is located in the discharge pipe 34. About a pump 35, it is allowable to use a method of circulating the high-temperature and high-pressure fluid forcibly in such a manner that the high-temperature and high-pressure fluid passing in the medium discharge path 31 is again supplied into the bladder 15 through the medium supply path 21.

Hereinafter, a description will be made about a procedure for vulcanizing and shaping the tire 9 by use of the mold 10. As illustrated in FIG. 2, the tire 9 is first set in the mold 10, and the bladder 15 is inflated to shape the tire 9 into a form close to the inside surface form of the mold 10. In this way, the tire 9 is held by the bladder 15 to be pushed onto the tread mold part 11, the lower mold part 12, and the upper mold part 13.

Subsequently, a heating step is carried out which is a step of performing outer heating of heating the mold 10 to heat the tire 9 from the tire outside surface side thereof, and inner heating of supplying a heating medium having a high temperature into the bladder 15 inside the mold 10 to heat the tire 9 from the inside surface side thereof.

The mold 10 is beforehand heated through the steam jacket. In this way, the outer heating is attained. The inner heating is attained after the shaping of the tire 9 by supplying the heating medium into the bladder 15 through the medium supply path 21. Subsequently to the supply of the heating medium for a predetermined period, the pressurizing medium is supplied into the bladder 15 to pressurize the tire 9 under high pressure. The heating medium is, for example, steam or high-temperature water. The pressurizing medium is, for example, an inert gas such as nitrogen gas or steam.

When the heat and pressure are applied to the tire 9 inside the mold 10, the temperature of the tread mold part 11 supplied for the outer heating, and the temperature for the inner heating are adjusted to satisfy the following expressions (1) and (2) simultaneously:

To/So=1.00 to 1.10 (1), and

To/Ti=0.70 to 0.90 (2)

wherein To (° C.) represents the temperature of the outside surface of the tread region in the vulcanizing step, So (° C.) represents the temperature of the outside surface of the side wall regions in the step, and Ti (° C.) represents the temperature of the inside surface of the tread region in the step. The temperature of the tread mold part 11 supplied for the outer heating may be adjusted by controlling the temperature of the heat source, such as the electric heater or steam jacket, set in the mold 10. The temperature for the inner heating may be adjusted by controlling the period during which the heating medium is supplied. Respective preferred temperature ranges of To, So and Ti for satisfying the expressions (1) and (2) simultaneously are, for example, as follows: 140° C.≦To (° C.)≦160° C., 130° C.≦So (° C.)≦160° C., and 185° C.≦Ti (° C.)≦205° C.

Since the pneumatic tire according to the present invention is a tire produced by the above-mentioned producing method, the fuel consumption performance thereof is consistent with the wet braking performance in a well balanced manner. About the pneumatic tire according to the present invention, the fuel consumption performance is improved, particularly, by optimizing conditions for the vulcanization of the tread region, and further the wet braking performance is improved while the side wall regions are restrained from being overcured, particularly, by optimizing conditions for the vulcanization of the side wall regions. The producing method according to the present invention is applicable to a method for producing a pneumatic tire that may have various sizes and shapes. However, about racing tires heightened in rigidity by making their carcass layer into a bias structure, or by some other technique, it is unnecessary that the rigidity of their side wall regions is heightened by optimizing the vulcanization conditions. Accordingly, the producing method according to the present invention is particularly useful as a method for producing any pneumatic tire other than racing tires.

The present invention is not limited to the above-mentioned embodiments. The embodiments may be variously improved or modified as far as the improved or modified embodiments do not depart from the scope of the subject matter of the present invention.

### EXAMPLES

### Examples 1 to 5, and Comparative Examples 1 to 6

In order to demonstrate the configuration of the present invention and the advantageous effects thereof, the vulcanizing mold 10 illustrated in FIG. 2 was used in each of the examples and the comparative examples to vulcanize tires (tire size: 195/65R15, and 15×6 JJ) for automobiles. When heat and pressure were applied to each of the tires 9 inside the mold 10, the temperature of the tread region 11 supplied for outer heating, and the temperature for inner heating were adjusted to satisfy To, So and Ti which are shown in Table 1.

In each of these examples, one of the vulcanized tires (tire size: 195/65R15, and 15×6 JJ) as a new product was used, and the fuel consumption performance thereof was evaluated by measuring the rolling resistance thereof. The measurement of the rolling resistance was made by using a roll resistance measuring drum in accordance with International Standard ISO 28580 (JIS D 4234) under conditions including the used air pressure of 210 kPa, the load of 4.82 kN, the test temperature of 23° C. and the test speed of 80 km/h. The result was represented by an index obtained when the result of Comparative Example 1 was regarded as 100. As the numerical value of the index of tires is smaller, the tires are better in fuel consumption performance. The results are shown in Table 1.

Furthermore, in each of these examples, four of the vulcanized tires (tire size: 195/65R15, and 15×6 JJ) as new products were used, and the wet braking performance thereof was evaluated. In the evaluations, the four new tires were fitted to an actual automobile (4-door sedan manufactured by a Japanese maker), and driven on a road surface watered into a water depth of 2 to 3 mm. At 100 km/h, the frictional coefficient of the tires was measured to evaluate the wet braking performance thereof. The result was represented by an index obtained when the result of Comparative Example 1 was regarded as 100. As the numerical value of the index of tires is larger, the tires are better in wet braking performance. The results are shown in Table 1.

TABLE 1

| | | | | | | Compar- | Compar- | Compar- | Compar- | Compar- | Compar- |
|---|---|---|---|---|---|---|---|---|---|---|---|
| | | | | | | ative | ative | ative | ative | ative | ative |
| | Exam- | Exam- | Exam- | Exam- | Exam- | Exam- | Exam- | Exam- | Exam- | Exam- | Exam- |
| | ple 1 | ple 2 | ple 3 | ple 4 | ple 5 | ple 1 | ple 2 | ple 3 | ple 4 | ple 5 | ple 6 |
| Tread region outside surface | 160 | 160 | 140 | 160 | 160 | 180 | 180 | 185 | 185 | 170 | 140 |
| temperature To (° C.) | | | | | | | | | | | |
| Side wall region outside | 160 | 160 | 140 | 155 | 150 | 180 | 180 | 180 | 170 | 140 | 150 |
| surface temperature So (° C.) | | | | | | | | | | | |
| Tread region inside surface | 193 | 186 | 186 | 186 | 186 | 193 | 186 | 200 | 200 | 183 | 205 |
| temperature (° C.) | | | | | | | | | | | |
| Temperature ratio To/So | 1.00 | 1.00 | 1.00 | 1.03 | 1.07 | 1.00 | 1.00 | 1.03 | 1.09 | 1.21 | 0.93 |
| Temperature ratio To/Ti | 0.83 | 0.86 | 0.75 | 0.86 | 0.86 | 0.93 | 0.97 | 0.93 | 0.93 | 0.93 | 0.68 |
| Performance for low fuel | 90 | 88 | 86 | 85 | 84 | 100 | 100 | 100 | 98 | — | — |
| consumption | | | | | | | | | | | |
| Wet braking performance | 99 | 99 | 100 | 103 | 102 | 100 | 101 | 95 | 101 | — | — |

From the results in Table 1, it is understood that the pneumatic tires produced by the respective producing methods according to Examples 1 to 5 were better in fuel consumption performance and wet braking performance than the pneumatic tires produced by the respective producing methods according to Comparative Examples 1 to 6. The pneumatic tires produced in Comparative Examples 5 and 6 were under-cured, so as not to be measurable in rolling resistance nor wet braking performance.
1 bead region
2 side wall region
3 tread region
6 tread rubber
7 cap tread
8 base tread
9 tire
10 mold

What is claimed is:

1. A method for producing a pneumatic tire, comprising a vulcanizing step of heating and vulcanizing, inside a mold, an unvulcanized green tire having a pair of bead regions, side wall regions extended, respectively, from the bead regions toward the outside of the tire in the radius direction of the tire, and a tread region extended and joined to an outside end of each of the side wall regions to form a tread, wherein
when To (° C.) represents the temperature of the outside surface of the tread region in the vulcanizing step, So (° C.) represents the temperature of the outside surface of the side wall regions in the step, and Ti (° C.) represents the temperature of the inside surface of the tread region in the step,
the following are satisfied:
To/So=1.00 to 1.10 (1), and
To/Ti=0.70 to 0.90 (2).

2. The pneumatic tire producing method according to claim 1, wherein the temperature To (° C.) of the outside surface of the tread region is 160° C. or lower.

3. The pneumatic tire producing method according to claim 1, wherein the temperature Ti (° C.) of the inside surface of the tread region is higher than 185° C.

4. A pneumatic tire, produced by the producing method according to claim 1.
